(19) United States
(12) Patent Application Publication
(10) Pub. No.: US 2026/0017962 A1
(43) Pub. Date: Jan. 15, 2026

(54) 3D OBJECT DETECTION

(71) Applicant: QUALCOMM Incorporated, San Diego, CA (US)

(72) Inventors: Venkatraman Narayanan, San Diego, CA (US); Varun Ravi Kumar, San Diego, CA (US); Senthil Kumar Yogamani, San Diego, CA (US)

(21) Appl. No.: 19/239,052

(22) Filed: Jun. 16, 2025

Related U.S. Application Data
(60) Provisional application No. 63/671,526, filed on Jul. 15, 2024.

(51) Int. Cl. G06V 20/70; G06V 10/82; G06V 20/58

(52) U.S. Cl. CPC G06V 20/70; G06V 10/82; G06V 20/58

(57) ABSTRACT

An apparatus for object detection includes memory and processing circuitry configured to obtain camera data and depth data representing a scene. The processing circuitry generates 3D bounding boxes for one or more objects in the scene based on the camera data and generates a 3D semantic segmentation from the depth data. Using the 3D bounding boxes and the 3D semantic segmentation, the processing circuitry calculates box statistics to determine which 3D bounding boxes correspond to true positive objects and which correspond to false positive objects. Final 3D bounding boxes for the true positive objects are then output.

### CLAIM OF PRIORITY

This application claims the benefit of U.S. Provisional Patent Application No. 63/671,526, filed 15 Jul. 2024, the entire contents of which is incorporated herein by reference.

### TECHNICAL FIELD

This disclosure relates to object detection in image and/or LiDAR data.

### BACKGROUND

Computer vision applications, including applications in automotives, make use of the detection and analysis of three-dimensional (3D) objects. 3D object detection may include the identification and localization of objects in 3D space using sensors like cameras, LiDAR, and radar. Algorithms process this data to recognize and position objects accurately, enhancing real-time situational awareness.

### SUMMARY

In general, this disclosure describes techniques for improving object detection by using camera data and depth data to more reliably identify objects in a scene. The techniques include generating three-dimensional (3D) bounding boxes for objects based on camera data and generating 3D semantic segmentation based on depth data, such as LiDAR or radar point clouds. Box-level statistical features are calculated using both the 3D bounding boxes and the semantic segmentation results to help determine which detections correspond to true positive objects and which correspond to false positives. In one approach, this classification is performed using threshold comparisons or machine learning models such as multi-layer perceptrons. In another approach, a graph-based method is used to capture contextual relationships between objects and scene features. In that case, a graph convolutional network (GCN) processes a graph with nodes representing object and semantic data and edges encoding contextual relationships, and uses the output to classify bounding boxes. These techniques reduce false positives while preserving true positives, improving object detection for advanced driver assistance systems (ADAS).

In one example, the techniques of this disclosure include an apparatus for object detection having memory and processing circuitry configured to obtain camera data and depth data representing a scene. In one example, the apparatus includes processing circuitry configured to generate 3D bounding boxes for one or more objects in the scene based on the camera data. In such an example, the apparatus includes processing circuitry configured to generate a 3D semantic segmentation from the depth data. According to these examples, the apparatus includes processing circuitry configured to calculate box statistics using the 3D bounding boxes and the 3D semantic segmentation. In such an example, the apparatus may determine which 3D bounding boxes correspond to true positive objects and which correspond to false positive objects and output final 3D bounding boxes for the true positive objects.

In one example, the techniques of this disclosure include a method for object detection in a scene. The method includes obtaining camera data and depth data representing the scene. In such an example, the method includes generating 3D bounding boxes for one or more objects in the scene based on the camera data. The method also includes generating a 3D semantic segmentation based on the depth data. According to this example, the method includes determining, using calculated box statistics based on the 3D bounding boxes and the 3D semantic segmentation, which of the 3D bounding boxes correspond to true positive objects and which correspond to false positive objects. The method further includes outputting final 3D bounding boxes for the true positive objects in the scene.

In one example, the techniques of this disclosure include a non-transitory computer-readable medium storing instructions that, when executed by processing circuitry, cause the processing circuitry to obtain camera data and depth data representing a scene. In such an example, the instructions cause the processing circuitry to generate 3D bounding boxes for one or more objects in the scene based on the camera data. The instructions further cause the processing circuitry to generate a 3D semantic segmentation based on the depth data. According to this example, the instructions also cause the processing circuitry to determine, using calculated box statistics based on the 3D bounding boxes and the 3D semantic segmentation, which of the 3D bounding boxes correspond to true positive objects and which correspond to false positive objects. The instructions further cause the processing circuitry to output final 3D bounding boxes for the true positive objects in the scene.

In one example, the techniques of this disclosure include a device for object detection in a scene. The device includes means for obtaining camera data and depth data representing the scene. In such an example, the device includes means for generating 3D bounding boxes for one or more objects in the scene based on the camera data. The device also includes means for generating a 3D semantic segmentation based on the depth data. According to this example, the device includes means for determining, using calculated box statistics based on the 3D bounding boxes and the 3D semantic segmentation, which of the 3D bounding boxes correspond to true positive objects and which correspond to false positive objects. The device further includes means for outputting final 3D bounding boxes for the true positive objects in the scene.

According to another example, this disclosure describes an apparatus for object detection having memory and processing circuitry configured to obtain camera data and depth data representing a scene. In such an example, the apparatus includes processing circuitry configured to generate 3D bounding boxes for one or more objects in the scene based on the camera data. The apparatus also includes processing circuitry configured to generate a 3D semantic segmentation based on the depth data. According to this example, the apparatus includes processing circuitry configured to construct a graph comprising nodes and edges, wherein the nodes represent the 3D bounding boxes and the 3D semantic segmentation and the edges represent contextual relationships among the nodes. In this example, the apparatus includes processing circuitry configured to generate, using a graph convolutional network (GCN), feature-enhanced node representations based on the graph. The apparatus is further configured to classify the 3D bounding boxes as true positive objects or false positive objects based at least in part on the feature-enhanced node representations generated by the graph convolutional network, and to output final 3D bounding boxes for the true positive objects.

In one example, the techniques of this disclosure include a method for object detection in a scene. The method includes obtaining camera data and depth data representing the scene. In such an example, the method includes generating 3D bounding boxes for one or more objects in the scene based on the camera data. The method also includes generating a 3D semantic segmentation based on the depth data. According to this example, the method includes constructing a graph comprising nodes and edges, wherein the nodes represent the 3D bounding boxes and the 3D semantic segmentation and the edges represent contextual relationships among the nodes. In this example, the method includes generating, using a graph convolutional network (GCN), feature-enhanced node representations based on the graph. The method further includes classifying the 3D bounding boxes as true positive objects or false positive objects based at least in part on the feature-enhanced node representations generated by the graph convolutional network and outputting final 3D bounding boxes for the true positive objects.

In one example, the techniques of this disclosure include a non-transitory computer-readable medium storing instructions that, when executed by processing circuitry, cause the processing circuitry to obtain camera data and depth data representing a scene. In such an example, the instructions cause the processing circuitry to generate 3D bounding boxes for one or more objects in the scene based on the camera data. The instructions further cause the processing circuitry to generate a 3D semantic segmentation based on the depth data. According to this example, the instructions also cause the processing circuitry to construct a graph comprising nodes and edges, wherein the nodes represent the 3D bounding boxes and the 3D semantic segmentation and the edges represent contextual relationships among the nodes. In this example, the instructions further cause the processing circuitry to generate, using a graph convolutional network (GCN), feature-enhanced node representations based on the graph. The instructions also cause the processing circuitry to classify the 3D bounding boxes as true positive objects or false positive objects based at least in part on the feature-enhanced node representations generated by the graph convolutional network and to output final 3D bounding boxes for the true positive objects.

In one example, the techniques of this disclosure include a device for object detection in a scene. The device includes means for obtaining camera data and depth data representing the scene. In such an example, the device includes means for generating 3D bounding boxes for one or more objects in the scene based on the camera data. The device also includes means for generating a 3D semantic segmentation based on the depth data. According to this example, the device includes means for constructing a graph comprising nodes and edges, wherein the nodes represent the 3D bounding boxes and the 3D semantic segmentation and the edges represent contextual relationships among the nodes. In this example, the device includes means for generating, using a graph convolutional network (GCN), feature-enhanced node representations based on the graph. The device further includes means for classifying the 3D bounding boxes as true positive objects or false positive objects based at least in part on the feature-enhanced node representations generated by the graph convolutional network and for outputting final 3D bounding boxes for the true positive objects.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle in accordance with the techniques of this disclosure for object detection.

FIG. 2 is a block diagram illustrating an example system that may perform the techniques of this disclosure for object detection.

FIG. 3 is a block diagram illustrating one example of the object detection unit of FIG. 2.

FIG. 4 is a block diagram illustrating another example of the object detection unit of FIG. 2.

FIG. 5 is a block diagram illustrating another example of the object detection unit of FIG. 2.

FIG. 6 is a flow diagram illustrating an example method for object detection, in accordance with one or more techniques of this disclosure.

### DETAILED DESCRIPTION

3D object detection models are useful for Advanced Driver Assistance Systems (ADAS). However, these models are often prone to false positives, which can negatively affect system reliability and safety. In many cases, the precision of object detection degrades in order to maintain high recall, particularly when object representations are sparse due to occlusion or distance from the sensors. The degradation of point density, especially in LiDAR data, makes accurate detection more challenging as distance increases or environmental complexity rises.

Sparse or low-quality detections may be misinterpreted as objects or noise, increasing the risk of misclassification. Environmental factors such as adverse weather, occlusion, lighting variation, and dense traffic exacerbate the difficulty of correctly identifying objects. As a result, false positives may cause unwarranted braking or maneuvering, reducing passenger comfort and safety. These detection errors complicate route planning and decision-making, undermining user trust and potentially delaying regulatory acceptance. The challenge lies in distinguishing true positives from false positives in the face of sensor sparsity, noise, and complex scene geometry.

In view of these drawbacks, this disclosure describes techniques for improving object detection accuracy by reducing false positives while preserving true positives. The techniques utilize camera data and depth data, such as LiDAR or radar point clouds, to generate three-dimensional (3D) bounding boxes for objects in a scene. The techniques further include generating 3D semantic segmentation based on the depth data and calculating box-level statistical features that correlate the bounding boxes and semantic data. These box statistics are then used to determine which bounding boxes correspond to true positive objects and which correspond to false positives.

In some examples, the box statistics may include one or more of the following: an average face distance of 3D points to each bounding box face, an average number of semantic points belonging to the same class as the bounding box class, and an average number of semantic points per face of the bounding box.

In one approach, the box statistics are compared to one or more predefined thresholds to classify the bounding boxes. In another approach, the box statistics are input into a machine learning model, such as a multi-layer perceptron (MLP), trained to distinguish between true positives and false positives. In a further approach, contextual relationships are captured by constructing a graph where nodes represent object-level and semantic features, and edges encode spatial or semantic relationships. A graph convolutional network (GCN) processes the graph to generate node representations, which are then used to classify the bounding boxes, optionally via an MLP. In each of these approaches, the bounding boxes classified as false positives are discarded, and final 3D bounding boxes are output for the true positive objects. These techniques may be implemented individually or in combination to enhance the reliability of object detection systems used in autonomous or semi-autonomous driving.

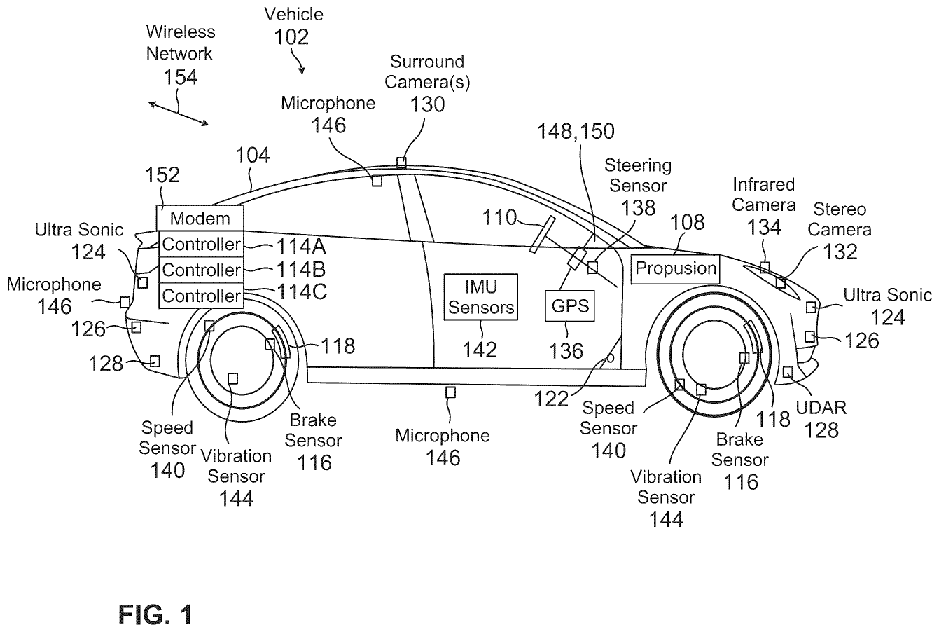

FIG. 1 shows an example vehicle 102. Vehicle 102 in the example shown may comprise a passenger vehicle such as a car or truck that can accommodate a human driver and/or human passengers. In one example, vehicle 102 may comprise an autonomous vehicle, semi-autonomous vehicle and may include an ADAS. Vehicle 102 may include a vehicle body 104 suspended on a chassis, in this example having of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below. Vehicle 102 may be an ego vehicle, which refers to the vehicle in which the object detection system or advanced driver assistance system (ADAS) is installed. All relative position, distance, and orientation references in this disclosure are made with respect to the coordinate frame of the ego vehicle.

Each controller 114 may be one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114n (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In one example, an actuation controller may include dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in one example, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit sensors (“IMU” sensors) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended. In one example, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

As discussed above, 3D object detection models are useful for ADAS. However, false positives in these 3D object detection models may significantly impact the reliability and safety of autonomous driving systems. Current methods depend on the density of points representing objects, which decreases with distance and occlusion, making accurate detection difficult. To maintain high recall rates, example 3D object detection models may compromise on precision, resulting in increased false positives.

Sparse point detections can be mistaken for noise or misclassified, causing errors in object recognition. Additionally, adverse weather conditions, high object density, and dynamic lighting further exacerbate the problem of false positives. These false positives can lead to unnecessary braking or evasive maneuvers, posing risks to passenger and road user safety. False positives also complicate route planning and obstacle avoidance, undermining trust in autonomous driving systems, and impeding user acceptance and regulatory approval. The challenge lies in differentiating between true and false positives due to sparse data representation, varying point densities, adverse environmental conditions, and the complexity of urban environments.

In view of these drawbacks, this disclosure describes techniques for object detection from a birds-eye-view (BEV) representation produced from one or more of image data and LiDAR data. Controller 114 may be configured to use both a BEV representation, as well as semantic segmentation data to reduce the number of false positives in object detection. The techniques of this disclosure combine algorithms, data augmentation, sensor fusion, post-processing, and contextual analysis to reduce false positives in an object detection task, while keeping true positives, thereby improving the overall performance of autonomous or semi-autonomous driving systems that may use the output of object detection process. A true positive object is a detected object whose 3D bounding box sufficiently overlaps with a corresponding ground truth object and shares a correct or semantically valid class label. Conversely, a false positive object refers to a detected object that either (i) does not correspond to any real object in the scene, or (ii) overlaps a real object but is assigned an incorrect class label or has low confidence based on box statistics. The determination may be made using thresholds, learned classifiers, or contextual models. A 3D bounding box refers to a cuboidal region in three-dimensional space that encloses an object. The bounding box may be defined by its center coordinates, orientation, and size parameters, and may also include class labels or confidence scores.

In one example, controller 114 may generate BEV camera features from image data of a scene as well as BEV LiDAR features from depth data (e.g., point cloud data) of a scene. Controller 114 may further generate initial 3D bounding boxes for objects in the scene from the BEV camera features and BEV LiDAR features. In addition, controller 114 may generate a 3D semantic segmentation of the scene based on the depth data.

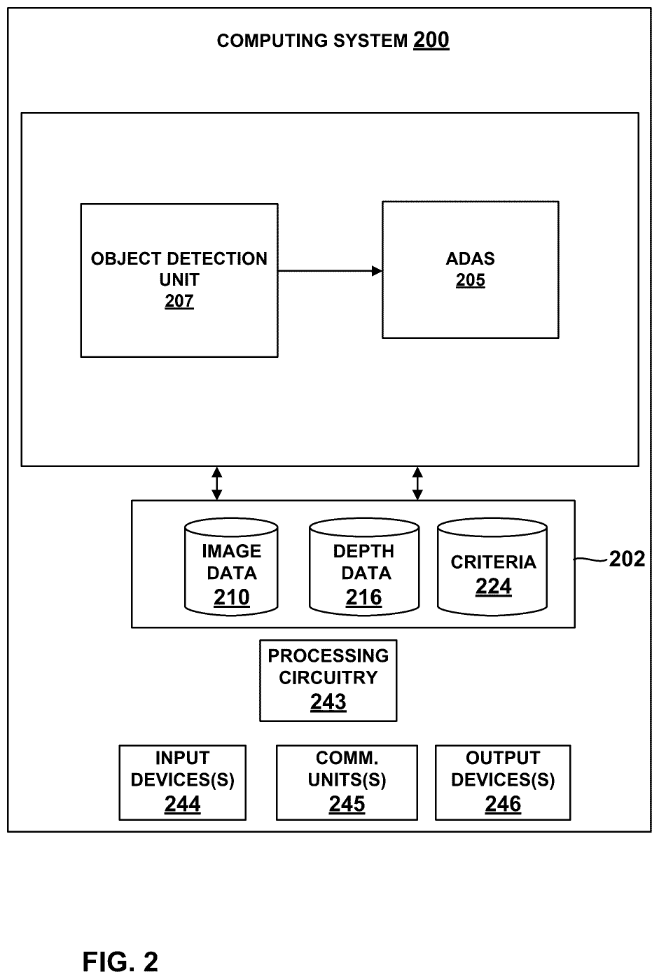

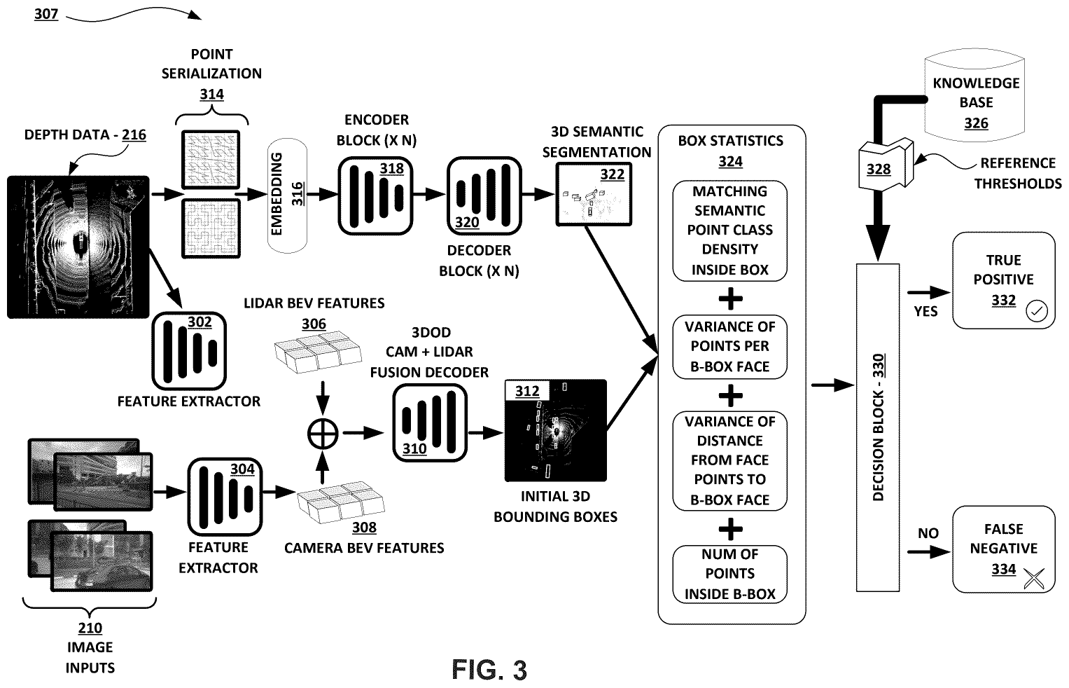

Controller 114 may further box statistics based on a comparison of the 3D semantic segmentation and the initial 3D bounding boxes. In one example, controller 114 compares criteria or statistics (e.g., criteria 224 at FIG. 2 and box statistics 324 at FIG. 3) to predetermined thresholds to determine if objects identified by the initial 3D bounding boxes are true positives or false positives. Box statistics refers to quantitative features calculated from 3D bounding boxes and associated semantic segmentation data. Example box statistics include: (1) the average distance of 3D points to each face of the bounding box; (2) the count of semantic points within the bounding box that belong to the same class as the predicted object class; and (3) the number of semantic points per face of the bounding box. These statistics serve as indicators of object fidelity and classification reliability. A semantic point is a 3D point that has been labeled with a category based on semantic segmentation. A “semantic class” is the assigned category, such as vehicle, pedestrian, or road sign, and is used to distinguish between object types in the point cloud data.

Controller 114 may affirmatively identify the false positives and output final 3D bounding boxes with the true positives. In an alternative example, rather than comparing the box statistics to predetermined thresholds, controller 114 processes the box statistics with a multi-layer perceptron (MLP) to determine the true positives and the false positives. In another example of the disclosure, controller 114 combines BEV features from the image data and the depth data with semantic segmentation features from the depth data 216 to form a graph construction. In such an example, controller 114 processes the graph construction using one or more graph convolution layers and an MLP to determine the true positives and the false positives. Additional details on the object detection techniques of this disclosure are described below with reference to FIGS. 2-5.

FIG. 2 is a block diagram illustrating an example computing system 200. As shown, computing system 200 comprises processing circuitry 243 and memory 202 for executing object detection unit 207 and ADAS 205, which may represent an example instance of any controller 114 described in this disclosure, such as controller 114 of FIG. 1. The example of FIG. 2 shows object detection unit 207 and ADAS 205 as being separate. In other examples, object detection unit 207 may be a sub-unit of ADAS 205.

Computing system 200 also be implemented as any suitable external computing system accessible by controller 114, such as one or more server computers, workstations, laptops, mainframes, appliances, cloud computing systems, High-Performance Computing (HPC) systems (e.g., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure for object detection may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., object detection unit 207 and/or ADAS 205), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute object detection unit 207 and/or ADAS 205 using virtualization modules, such as a virtual machine or container executing on underlying hardware. One or more of such modules may execute as one or more services of an operating system or computing platform. Aspects of computing system 200 may execute as one or more executable programs at an application layer of a computing platform.

One or more input devices 244 of computing system 200 may generate, receive, or process input. Such input may include input from a video camera, ranging sensor (e.g., one or more of radar, sonar, LiDAR, etc.), keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, computing system 200 may be configured to execute object detection unit 207. As will be described in more detail below, object detection unit 207 may be configured to detect the 3D location of objects in the vicinity of computing system 200 (e.g., near vehicle 102 of FIG. 1) using both image data 210 and depth data 216 (e.g., form a LiDAR sensor). Image data 210 may be one or frames of image data captured by any number of cameras 130-134 shown in FIG. 1. As will be explained in more detail below with reference to FIGS. 3-5, object detection unit 207 may be configured to detect objects in a scene capture in image data 210 and depth data 216 (e.g., point cloud data) in a manner that reduces false positives relative to other techniques.

For example, object detection unit 207 may generate camera BEV features from image data 210 of a scene, and generate LiDAR BEV features from depth data 216 of the scene. Object detection unit 207 may be further configured to generate initial 3D bounding boxes for one or more initial objects in a scene from the camera BEV features and the LIDAR BEV features. Object detection unit 207 also generates a 3D semantic segmentation from the depth data 216. Object detection unit 207 may then generate box statistics using the initial 3D bounding boxes and the 3D semantic segmentation, and determine true positive objects and false positive objects from box statistics in the scene.

In some examples, criteria 224 or box statistics 324 (e.g., see FIG. 3) may include one or more of the following: an average face distance of 3D points to each bounding box face, an average number of semantic points belonging to the same class as the bounding box class, and an average number of semantic points per face of the bounding box. These may be computed as follows:

### Average Face Distance of Points to Each Bounding Box Face, Set Forth Below, as Follows:

$${d}_{avg} ( {f}_{i} ) = \frac{1}{{N}_{i}} {\sum }_{p ∈ {P}_{i}} distance ( p , {f}_{i} ) .$$

### Average Number of Semantic Points Belonging to the Same Class as the Bounding Box Class:

$${n}_{avg} = \frac{1}{\vert B \vert} {\sum }_{p ∈ {P}_{i}} I ( class ( p ) = class ( B ) ) .$$

### Average Number of Semantic Points Per Face of the Bounding Box:

$${s}_{avg} ( {f}_{i} ) = \frac{1}{\vert {f}_{i} \vert} {\sum }_{p ∈ {P}_{i}} I ( class ( p ) = class ( {f}_{i} ) ) .$$

Here, Pᵢ denotes the set of points associated with face fᵢ; B is the set of points within the bounding box; and II is an indicator function that returns 1 if the condition is true, and 0 otherwise.

Object detection unit 207 may output final 3D bounding boxes with the true positive objects in the scene.

In one example, to determine the true positive objects and the false positive objects from the box statistics, object detection unit 207 is configured to determine the true positive objects and the false positive objects based on a comparison of the box statistics to one or more thresholds. In another example, to determine the true positive objects and the false positive objects from the box statistics, object detection unit 207 is further configured to process the box statistics with a multi-layer perceptron (MLP) to determine the true positive objects and the false positive objects.

In another example of the disclosure, object detection unit 207 is configured to generate camera BEV features from image data 210 of a scene, and generate LiDAR BEV features from depth data 216 of the scene. Object detection unit 207 may be further configured to generate object features from the camera BEV features and the LIDAR BEV features. Object detection unit 207 may also generate 3D semantic segmentation features from the point cloud data (e.g., represented within depth data 216), and generate a graph construction from the object features and the 3D semantic segmentation features. Object detection unit 207 may process the graph construction with one or more graph convolution layers to generate an intermediate output, and process the intermediate output true with an MLP to determine true positive objects and false positive objects in the scene. Object detection unit 207 may output final 3D bounding boxes with the true positive objects in the scene.

FIG. 3 is a block diagram illustrating one example of the object detection unit of FIG. 2. FIG. 3 shows an object detection unit 307 that is one example of object detection unit 207 of FIG. 2.

Objection detection unit 307 takes depth data 216 and image data 210 as inputs. Feature extractor 302 is a feature encoder configured to extract features from depth data 216 to generate LiDAR BEV features 306. Feature extractor 304 is a feature encoder configured to extract features from image data 210 to produce camera BEV features 308. LiDAR BEV features 306 and camera BEV features 308 are combined and then processed by 3D object detection (3DOD) fusion decoder 310 to generate initial bounding boxes 312 in the BEV representation. Initial bounding boxes 312 indicate the estimated location of objects in the scene captured in depth data 216 and image data 210. Initial bounding boxes 312 may or may not include false positives. That is, initial bounding boxes 312 may include bounding boxes for objects that are not actually in the scene.

In one example, to address false positives issues in 3D object detection for autonomous driving applications, object detection unit 307 may use a post-processing technique with the initial 3D bounding boxes and a 3D semantic segmentation 322 produced from depth data 216. In one example of 3D semantic segmentation process for depth data 216, point serialization unit 314 and embedding unit 316 are configured to the depth data 216 for analysis. Point serialization unit 314 may convert raw 3D depth data 216 collected by LiDAR sensors into a structured format that can be efficiently processed by computational algorithms. Point serialization unit 314 may organize the raw point cloud data, which may be in an unordered format, into a structured sequence by sorting the points based on their spatial coordinates or any other relevant criteria. Each point may be assigned a unique index to maintain its position within the sequence, which helps in tracking the points during subsequent processing steps. The attributes associated with each point, such as intensity, are encoded into a standardized format to ensure consistency and compatibility with the segmentation algorithm. The organized and indexed points are then formatted into a serialized data structure, such as a list or array, which can be easily fed into the embedding process.

Embedding unit 316 transforms the serialized points into a high-dimensional feature space that captures the geometric and contextual information of the points. This step enables the segmentation algorithm (e.g., segmentation encoder 318 and segmentation decoder 320) to effectively distinguish between different objects and surfaces in the depth data 216. The embedding process involves passing each point in the serialized sequence through a series of feature extraction layers, which can include convolutional neural networks (CNNs), multi-layer perceptrons (MLPs), or other types of neural networks that learn to capture relevant features from the raw point data.

Segmentation encoder 318 and segmentation decoder 320 then processes the output of embedding unit 316 to produce 3D semantic segmentation 322. 3D semantic segmentation 322 includes a class label for each point in the depth data 216, identifying the semantic category to which each point belongs.

Object detection unit 307 may then generate so-called “box statistics” from 3D semantic segmentation 322 and initial bounding boxes 312. Box statistics 324 may include the average face distance of points to each bounding box face, the average number of semantic points belonging to the same class as the bounding box class, and the average number of semantic points per face of the bounding box. These statistics are utilized to create a knowledge database 326, populated with manual annotations, to develop a robust post-processing logic for distinguishing false positives from true positives. Knowledge database 326 may include precomputed thresholds, statistical distributions, or rule sets based on annotated training data. Rule sets in the knowledge database 326 may be created manually, created automatically, or represent a human curated list from various sources, including automatically generated rules. Data, such as thresholds, from knowledge database 326 may be used to compare observed box statistics against expected values to classify bounding boxes.

Additionally, box statistics 324 references are categorized by different object types and their distance from the ego-vehicle, enabling context-aware decision-making.

### Average Face Distance of Points to Each Bounding Box Face:

$${d}_{avg} ( {f}_{i} ) = \frac{1}{{N}_{i}} {\sum }_{p ∈ {P}_{i}} distance ( p , {f}_{i} )$$

### Average Number of Semantic Points Belonging to the Same Class as the Bounding Box Class:

$${n}_{avg} = \frac{1}{\vert B \vert} {\sum }_{p ∈ {P}_{i}} I ( class ( p ) = class ( B ) )$$

### Average Number of Semantic Points Per Face of the Bounding Box:

$${s}_{avg} ( {f}_{i} ) = \frac{1}{\vert {f}_{i} \vert} {\sum }_{p ∈ {P}_{i}} I ( class ( p ) = class ( {f}_{i} ) )$$

Object detection unit 307 may use various criteria relating to box statistics 324 compared to reference thresholds 328 in decision block 330 to determine if particular bounding boxes of the initial 3D bounding boxes are true positives 332 (e.g., actually and correctly represent objects) or false positive 334 (e.g., do not represent objects in actuality). The criteria may include matching semantic class density inside the box, the variants of points per bounding box (b-box or bbox) face, the variance of distance from face points to the bounding box face, and the number of points in the bounding box. As one example, a particular bounding box may have an average face distance that is 10 cm. From a training dataset, the threshold for average face distance may be 5 cm with +/−2 cm deviation for true positives. In this example, decision block 330 would classify the bounding box as false positive 334.

After all bounding boxes have been evaluated, object detection unit 307 may discard objects identified as false positives 334 and output final 3D bounding boxes having only true positives 332.

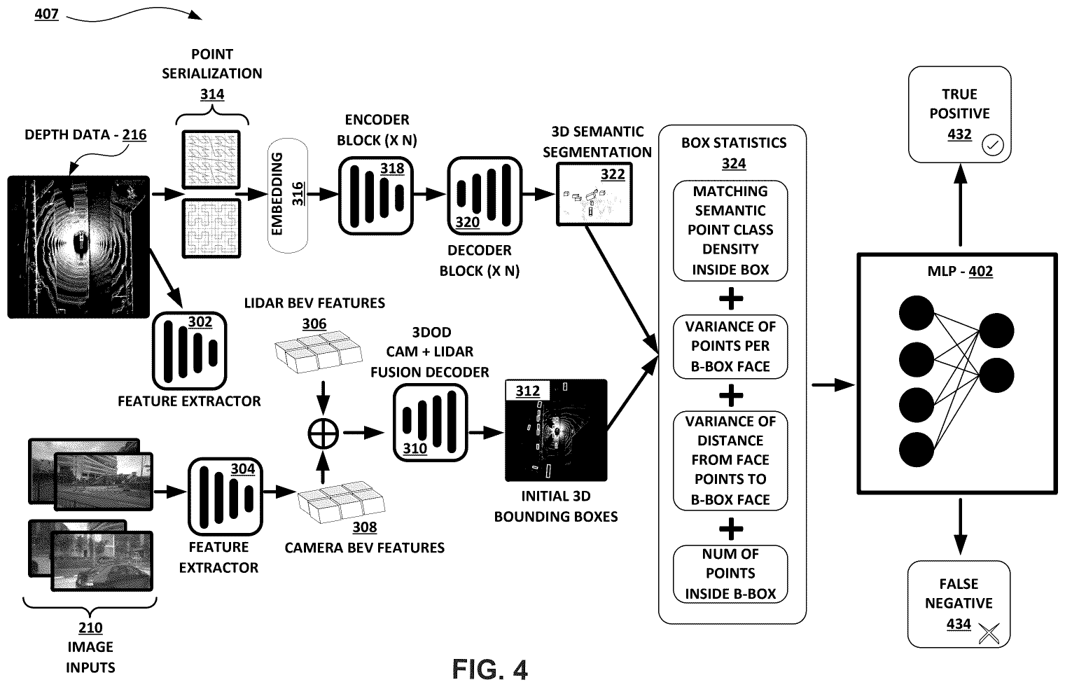

FIG. 4 is a block diagram illustrating another example of the object detection unit of FIG. 2. FIG. 4 shows an object detection unit 407 that is one example of object detection unit 207 of FIG. 2. Components of object detection unit 407 with the same reference numerals as those in object detection unit 307 are the same. However, the decision block, thresholds and knowledge database are replaced with MLP 402.

To further reduce false positives in 3D object detection, objection detection unit 407 uses MLP 402. MLP 402 is trained to differentiate between false positives 434 and true positives 432 by learning from statistical patterns, thereby enhancing the classification accuracy of object detection unit 407. Using MLP 402 improves the robustness of the false positive removal system by converting the logic into learnable parameters. This system improves over time through the machine learning process, as it continuously learns from new data.

Unlike hard-coded mechanisms and techniques, MLP 402 may be configured to adapt to new patterns and scenarios, making it more flexible and effective in various environments and conditions. MLP 402 may learn complex relationships and patterns in the data that are not easily captured by rule-based systems, leading to improved understanding of true object characteristics. This learning approach leverages the statistical features to enhance the capability of object detection unit 407 to accurately classify objects, reducing the occurrence of false positives by improving the model's understanding of true object characteristics.

MLP 402 may be trained using a labeled dataset containing examples of true and false positives, where each example includes the corresponding box statistics. Box statistics 324 described previously serve as input features for MLP 402. Use of MLP 402 may also improve robustness across diverse operational scenarios, including complex occlusions, ambiguous geometries, overlapping objects, and low-visibility conditions, improving temporal consistency, semantic disambiguation, or detection fidelity across varying scales and lighting environments.

MLP 402 may include an input layer, one or more hidden layers, and an output layer. Each layer may be composed of neurons that apply weighted sums and activation functions to the input data.

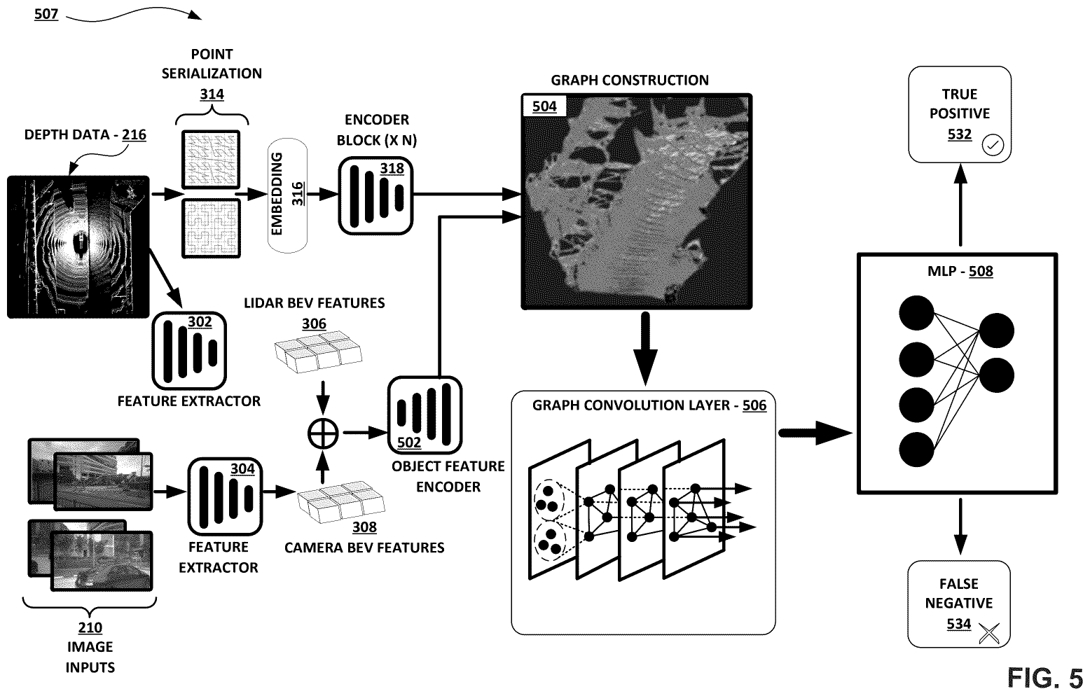

FIG. 5 is a block diagram illustrating another example of the object detection unit of FIG. 2. FIG. 5 shows an object detection unit 507 that is one example of object detection unit 207 of FIG. 2. Components of object detection unit 507 with the same reference numerals as those in object detection units 307 and 407 are the same. In general, rather than generating initial 3D bounding boxes, object detection unit 507 may generate combined BEV features (e.g., from both camera BEV features 308 and LiDAR BEV features 306) using object feature encoder 502 to produce object-level feature vectors. For example, a graph may be constructed using the object-level and semantic-level features as nodes and defining edges based on spatial proximity, feature similarity, or other scene-specific relationships. Rather than producing a full 3D semantic segmentation, object detection unit 507 may include segmentation encoder 318 that generates semantic segmentation features. Object detection unit 507 may construct a graph using the object features and semantic segmentation features via graph construction unit 504. The graph may then be processed by one or more graph convolution layers 506 and MLP 508 to classify detections as true positives 532 or false positives 534.

Graph convolution layers 506 may be a multi-task context graph network trained to integrate the intermediate features (e.g., the object features and the semantic segmentation features) from both object detection and semantic segmentation tasks. Graph convolution layers 506 are part of a graph convolutional network (GCN) that captures the contextual relationships between detected objects and their surrounding environment. By leveraging the combined features and the graph structure, object detection unit 507 may more effectively differentiate between false positives and true positives. The techniques of FIG. 5 enhance the contextual awareness of object detection unit 507, allowing for more accurate and reliable object detection in complex environments.

GCNs effectively model the interactions and dependencies between different objects and features by representing them as nodes and edges in a graph. GCNs can capture higher-order relationships by propagating information across multiple layers of the graph, allowing for a deeper understanding of the scene. By analyzing the entire graph structure, GCNs provide a holistic understanding of the scene, integrating various pieces of contextual information, rather than only a few specific manually formulated statistics. Nodes represent detected objects and semantic features. Each node contains feature vectors derived from the intermediate outputs of the object detection and semantic segmentation networks. Edges represent the relationships between these nodes, which include spatial proximity, semantic similarity, and other contextual relationships. In this context, a graph consists of nodes and edges, in which each node represents an object-level or semantic-level feature, and each edge represents a spatial or contextual relationship. The graph may be processed using a graph convolutional network to classify detected objects.

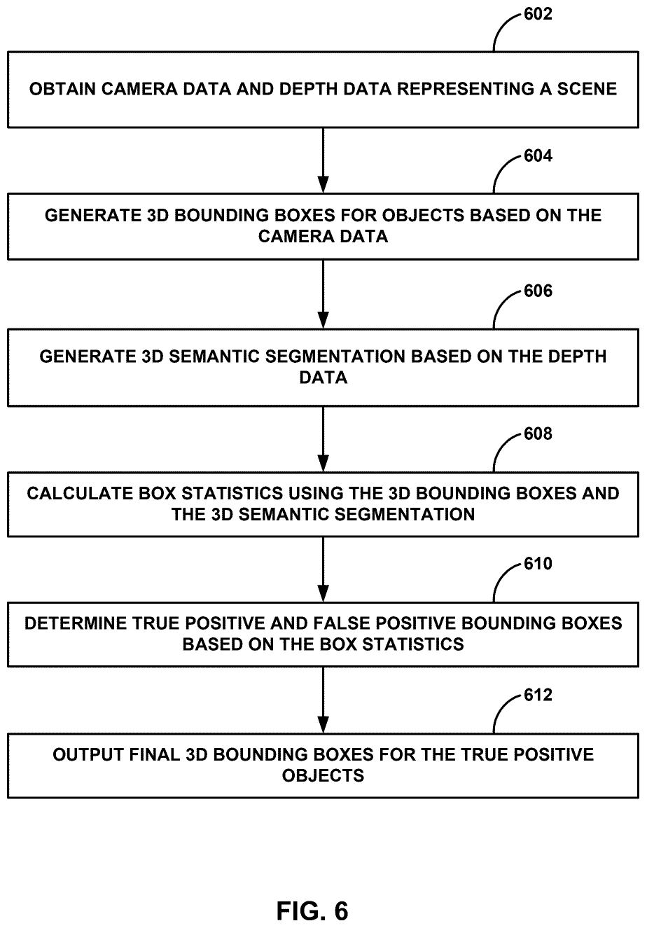

FIG. 6 is a flow diagram illustrating an example method for object detection, in accordance with one or more techniques of this disclosure. FIG. 6 is described with respect to vehicle 102 of FIG. 1, processing circuitry 243 and computing system 200 of FIG. 2, and the techniques for object detection as discussed in FIGS. 3, 4, and 5. However, the techniques of FIG. 6 may be performed by different components of vehicle 102 and computing system 200 or by additional or alternative systems.

Processing circuitry 243 of computing system 200 may be configured to obtain camera data and depth data representing a scene (602).

Processing circuitry 243 of computing system 200 may be configured to generate 3D bounding boxes for objects based on the camera data (604).

Processing circuitry 243 of computing system 200 may be configured to generate 3D semantic segmentation based on the depth data (606).

Processing circuitry 243 of computing system 200 may be configured to calculate box statistics using the 3D bounding boxes and the 3D semantic segmentation (608).

Processing circuitry 243 of computing system 200 may be configured to determine true positive and false positive bounding boxes based on box statistics 324 (610). For example, processing circuitry 243 may be configured to determine, using calculated box statistics based on the 3D bounding boxes and the 3D semantic segmentation, which of the 3D bounding boxes correspond to true positive objects and which correspond to false positive objects.

Processing circuitry 243 of computing system 200 may be configured to output final 3D bounding boxes for the true positive objects (612).

Additional aspects of the disclosure are detailed in numbered clauses below.

Clause 1—An apparatus for object detection in a scene, the apparatus comprising: a memory; and processing circuitry coupled to the memory and configured to: obtain camera data and depth data representing the scene; generate 3D bounding boxes for one or more objects in the scene based on the camera data; generate a 3D semantic segmentation based on the depth data; determine, using calculated box statistics based on the 3D bounding boxes and the 3D semantic segmentation, which of the 3D bounding boxes correspond to true positive objects and which correspond to false positive objects; and output final 3D bounding boxes for the true positive objects in the scene.

Clause 2—The apparatus of clause 1, wherein to determine which of the 3D bounding boxes correspond to the true positive objects and which correspond to the false positive objects, the processing circuitry is further configured to: obtain one or more thresholds from a knowledge database; and compare the calculated box statistics to the one or more thresholds to determine whether each 3D bounding box corresponds to one true positive object or one false positive object.

Clause 3—The apparatus of clause 2, wherein the one or more thresholds obtained from the knowledge database are selected based at least in part on a type of object associated with the 3D bounding box or a distance between the 3D bounding box and an ego vehicle.

Clause 4—The apparatus of any of clauses 1-3, wherein to determine which of the 3D bounding boxes correspond to the true positive objects and which correspond to the false positive objects, the processing circuitry is further configured to: provide the calculated box statistics to a multi-layer perceptron (MLP) trained to classify the 3D bounding boxes as corresponding to either the true positive objects or the false positive objects; and wherein to determine which of the 3D bounding boxes correspond to the true positive objects and which correspond to the false positive objects, the processing circuitry is further configured to: classify, using the multi-layer perceptron, each of the 3D bounding boxes as either one true positive object or one false positive object.

Clause 5—The apparatus of clause 4, wherein the processing circuitry is further configured to: train the multi-layer perceptron using labeled data comprising examples of the true positive objects and the false positive objects, each associated with corresponding box statistics.

Clause 6—The apparatus of any of clauses 1-5, wherein the processing circuitry is further configured to: calculate the box statistics based on the 3D bounding boxes and the 3D semantic segmentation using one or more of a semantic point class distribution within each 3D bounding box, a variance of distances from 3D points to corresponding faces of each 3D bounding box, a count of 3D points within each 3D bounding box, and a distribution of semantic point labels across the faces of each 3D bounding box.

Clause 7—The apparatus of any of clauses 1-6, wherein the processing circuitry is further configured to: calculate the box statistics using an average number of semantic points per face of each 3D bounding box.

Clause 8—The apparatus of any of clauses 1-7, wherein the processing circuitry is further configured to: generate bird's-eye view (BEV) features from the camera data and the depth data; and wherein, to generate the 3D bounding boxes for the one or more objects in the scene, the processing circuitry is further configured to generate the 3D bounding boxes based at least in part on the BEV features.

Clause 9—The apparatus of any of clauses 1-8, wherein to generate the 3D bounding boxes for the one or more objects in the scene based on the camera data, the processing circuitry is further configured to: fuse bird's-eye view (BEV) features derived from the camera data and from the depth data; and generate the 3D bounding boxes based at least in part on the fused BEV features.

Clause 10—The apparatus of any of clauses 1-9, wherein the depth data comprises point cloud data obtained from a LiDAR sensor or a radar sensor, or both.

Clause 11—The apparatus of any of clauses 1-10, wherein the processing circuitry is further configured to: generate a set of initial 3D bounding boxes for one or more candidate objects in the scene based on the camera data; and wherein, to output the final 3D bounding boxes for the true positive objects in the scene, the processing circuitry is further configured to output the final 3D bounding boxes as a subset of the initial 3D bounding boxes, the initial 3D bounding boxes comprising both true positive objects and the false positive objects.

Clause 12—The apparatus of any of clauses 1-11, wherein the processing circuitry is further configured to make a driving decision based at least in part on the final 3D bounding boxes.

Clause 13—The apparatus of any of clauses 1-12: wherein the apparatus is a vehicle; and wherein the processing circuitry is part of an advanced driver assistance system (ADAS).

Clause 14—The apparatus of any of clauses 1-13, wherein to determine which of the 3D bounding boxes correspond to the true positive objects and which correspond to the false positive objects, the processing circuitry is further configured to: construct a graph comprising nodes and edges, wherein the nodes represent the 3D bounding boxes and the 3D semantic segmentation and further wherein the edges represent contextual relationships amongst the nodes; generate, using a graph convolutional network (GCN), feature-enhanced node representations based on the graph; and classify the 3D bounding boxes as the true positive objects or the false positive objects based at least in part on the feature-enhanced node representations generated by the graph convolutional network.

Clause 15—An apparatus for object detection in a scene, the apparatus comprising: a memory; and processing circuitry coupled to the memory and configured to: obtain camera data and depth data representing the scene; generate 3D bounding boxes for one or more objects in the scene based on the camera data; generate a 3D semantic segmentation based on the depth data; construct a graph comprising nodes and edges, wherein the nodes represent the 3D bounding boxes and the 3D semantic segmentation and wherein the edges represent contextual relationships among the nodes; generate, using a graph convolutional network (GCN), feature-enhanced node representations based on the graph; classify the 3D bounding boxes as true positive objects or false positive objects based at least in part on the feature-enhanced node representations generated by the graph convolutional network; and output final 3D bounding boxes for the true positive objects in the scene.

Clause 16—The apparatus of clause 15, wherein the edges of the graph represent one or more contextual relationships selected based on one or more of: spatial proximity between nodes, semantic similarity between node features, or co-occurrence within a defined region of the scene.

Clause 17—The apparatus of clause 15 or 16, wherein the processing circuitry is further configured to: classify the 3D bounding boxes based at least in part on outputs of a multi-layer perceptron (MLP) that receives the feature-enhanced node representations generated by the graph convolutional network.

Clause 18—A method for object detection in a scene, the method comprising: obtaining camera data and depth data representing the scene; generating 3D bounding boxes for one or more objects in the scene based on the camera data; generating a 3D semantic segmentation based on the depth data; determining, using calculated box statistics based on the 3D bounding boxes and the 3D semantic segmentation, which of the 3D bounding boxes correspond to true positive objects and which correspond to false positive objects; and outputting final 3D bounding boxes for the true positive objects in the scene.

Clause 19—The method of clause 18, wherein determining which of the 3D bounding boxes correspond to the true positive objects and which correspond to the false positive objects comprises: providing the calculated box statistics to a multi-layer perceptron (MLP) trained to classify the 3D bounding boxes as corresponding to either the true positive objects or the false positive objects; and classifying, using the multi-layer perceptron, each of the 3D bounding boxes as either one true positive object or one false positive object.

Clause 20—The method of clause 18 or 19, wherein determining which of the 3D bounding boxes correspond to the true positive objects and which correspond to the false positive objects comprises: obtaining one or more thresholds from a knowledge database; and comparing the calculated box statistics to the one or more thresholds to determine whether each 3D bounding box corresponds to one true positive object or one false positive object.

Clause 21—The method of any of clauses 18-20, wherein calculating the box statistics comprises: calculating the box statistics based on the 3D bounding boxes and the 3D semantic segmentation using one or more of: a semantic point class distribution within each 3D bounding box, a variance of distances from 3D points to corresponding faces of each 3D bounding box, a count of 3D points within each 3D bounding box, and a distribution of semantic point labels across the faces of each 3D bounding box.

Clause 22—The method of any of clauses 18-21, further comprising: calculating the box statistics using an average number of semantic points per face of each 3D bounding box.

Clause 23—A non-transitory computer-readable medium storing instructions that, when executed by processing circuitry, cause the processing circuitry to: obtain camera data and depth data representing a scene; generate 3D bounding boxes for one or more objects in the scene based on the camera data; generate a 3D semantic segmentation based on the depth data; determine, using calculated box statistics based on the 3D bounding boxes and the 3D semantic segmentation, which of the 3D bounding boxes correspond to true positive objects and which correspond to false positive objects; and output final 3D bounding boxes for the true positive objects in the scene.

Clause 24—A computer program product comprising one or more instructions that, when executed by at least one processor, cause the at least one processor to perform any of the methods of clauses 18-22.

Clause 25—A device comprising means for performing any of the methods of clauses 18-22.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for object detection in a scene, the apparatus comprising:
a memory; and
processing circuitry coupled to the memory and configured to:
obtain camera data and depth data representing the scene;
generate 3D bounding boxes for one or more objects in the scene based on the camera data;
generate a 3D semantic segmentation based on the depth data
determine, using calculated box statistics based on the 3D bounding boxes and the 3D semantic segmentation, which of the 3D bounding boxes correspond to true positive objects and which correspond to false positive objects; and
output final 3D bounding boxes for the true positive objects in the scene.

2. The apparatus of claim 1, wherein to determine which of the 3D bounding boxes correspond to the true positive objects and which correspond to the false positive objects, the processing circuitry is further configured to:
obtain one or more thresholds from a knowledge database; and
compare the calculated box statistics to the one or more thresholds to determine whether each 3D bounding box corresponds to one true positive object or one false positive object.

3. The apparatus of claim 2, wherein the one or more thresholds obtained from the knowledge database are selected based at least in part on a type of object associated with the 3D bounding box or a distance between the 3D bounding box and an ego vehicle.

4. The apparatus of claim 1, wherein to determine which of the 3D bounding boxes correspond to the true positive objects and which correspond to the false positive objects, the processing circuitry is further configured to:
provide the calculated box statistics to a multi-layer perceptron (MLP) trained to classify the 3D bounding boxes as corresponding to either the true positive objects or the false positive objects; and
wherein to determine which of the 3D bounding boxes correspond to the true positive objects and which correspond to the false positive objects, the processing circuitry is further configured to:
classify, using the multi-layer perceptron, each of the 3D bounding boxes as either one true positive object or one false positive object.

5. The apparatus of claim 4, wherein the processing circuitry is further configured to:
train the multi-layer perceptron using labeled data comprising examples of the true positive objects and the false positive objects, each associated with corresponding box statistics.

6. The apparatus of claim 1, wherein the processing circuitry is further configured to:
calculate the box statistics based on the 3D bounding boxes and the 3D semantic segmentation using one or more of a semantic point class distribution within each 3D bounding box, a variance of distances from 3D points to corresponding faces of each 3D bounding box, a count of 3D points within each 3D bounding box, and a distribution of semantic point labels across the faces of each 3D bounding box.

7. The apparatus of claim 1, wherein the processing circuitry is further configured to:
calculate the box statistics using an average number of semantic points per face of each 3D bounding box.

8. The apparatus of claim 1, wherein the processing circuitry is further configured to:
generate bird's-eye view (BEV) features from the camera data and the depth data; and
wherein, to generate the 3D bounding boxes for the one or more objects in the scene, the processing circuitry is further configured to generate the 3D bounding boxes based at least in part on the BEV features.

9. The apparatus of claim 1, wherein to generate the 3D bounding boxes for the one or more objects in the scene based on the camera data, the processing circuitry is further configured to:
fuse bird's-eye view (BEV) features derived from the camera data and from the depth data; and
generate the 3D bounding boxes based at least in part on the fused BEV features.

10. The apparatus of claim 1, wherein the depth data comprises point cloud data obtained from a LiDAR sensor or a radar sensor, or both.

11. The apparatus of claim 1, wherein the processing circuitry is further configured to:
generate a set of initial 3D bounding boxes for one or more candidate objects in the scene based on the camera data; and
wherein, to output the final 3D bounding boxes for the true positive objects in the scene, the processing circuitry is further configured to output the final 3D bounding boxes as a subset of the initial 3D bounding boxes, the initial 3D bounding boxes comprising both the true positive objects and the false positive objects.

12. The apparatus of claim 1, wherein the processing circuitry is further configured to make a driving decision based at least in part on the final 3D bounding boxes.

13. The apparatus of claim 1:
wherein the apparatus is a vehicle; and
wherein the processing circuitry is part of an advanced driver assistance system (ADAS).

14. The apparatus of claim 1, wherein to determine which of the 3D bounding boxes correspond to the true positive objects and which correspond to the false positive objects, the processing circuitry is further configured to:
construct a graph comprising nodes and edges, wherein the nodes represent the 3D bounding boxes and the 3D semantic segmentation and further wherein the edges represent contextual relationships amongst the nodes;
generate, using a graph convolutional network (GCN), feature-enhanced node representations based on the graph; and
classify the 3D bounding boxes as the true positive objects or the false positive objects based at least in part on the feature-enhanced node representations generated by the graph convolutional network.

15. A method for object detection in a scene, the method comprising:
obtaining camera data and depth data representing the scene;
generating 3D bounding boxes for one or more objects in the scene based on the camera data;
generating a 3D semantic segmentation based on the depth data;
determining, using calculated box statistics based on the 3D bounding boxes and the 3D semantic segmentation, which of the 3D bounding boxes correspond to true positive objects and which correspond to false positive objects; and
outputting final 3D bounding boxes for the true positive objects in the scene.

16. The method of claim 15, wherein determining which of the 3D bounding boxes correspond to the true positive objects and which correspond to the false positive objects comprises:
providing the calculated box statistics to a multi-layer perceptron (MLP) trained to classify the 3D bounding boxes as corresponding to either the true positive objects or the false positive objects; and
classifying, using the multi-layer perceptron, each of the 3D bounding boxes as either one true positive object or one false positive object.

17. The method of claim 15, wherein determining which of the 3D bounding boxes correspond to the true positive objects and which correspond to the false positive objects comprises:
obtaining one or more thresholds from a knowledge database; and
comparing the calculated box statistics to the one or more thresholds to determine whether each 3D bounding box corresponds to one true positive object or one false positive object.

18. The method of claim 15, wherein calculating the box statistics comprises:
calculating the box statistics based on the 3D bounding boxes and the 3D semantic segmentation using one or more of:
a semantic point class distribution within each 3D bounding box, a variance of distances from 3D points to corresponding faces of each 3D bounding box, a count of 3D points within each 3D bounding box, and a distribution of semantic point labels across the faces of each 3D bounding box.

19. The method of claim 15, further comprising:
calculating the box statistics using an average number of semantic points per face of each 3D bounding box.

20. A non-transitory computer-readable medium storing instructions that, when executed by processing circuitry, cause the processing circuitry to:
obtain camera data and depth data representing a scene;
generate 3D bounding boxes for one or more objects in the scene based on the camera data;
generate a 3D semantic segmentation based on the depth data;
determine, using calculated box statistics based on the 3D bounding boxes and the 3D semantic segmentation, which of the 3D bounding boxes correspond to true positive objects and which correspond to false positive objects; and
output final 3D bounding boxes for the true positive objects in the scene.
